(19) United States
(12) Patent Application Publication
(10) Pub. No.: US 2006/0003059 A1
(43) Pub. Date: Jan. 5, 2006

(54) Combined preparation and apparatus for use with a food blender and method for making preparation

(76) Inventor: Burt Tabora, Franklin, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/174,937

(22) Filed: Jul. 5, 2005

Related U.S. Application Data
(60) Provisional application No. 60/585,215, filed on Jul. 2, 2004.

(51) Int. Cl. A23B 4/00

(52) U.S. Cl. 426/231

(57) ABSTRACT

The invention provides for a food container that combines food-holding capabilities with food-measuring capabilities and with food-serving capabilities. The container may include a pre-packaged base food preparation. The base food preparation is then removed from the container and a second food preparation is measured using the indicia on the container. The method of the present invention provides for removing the base food preparation from the container, adding readily-available food product, such as a liquid or a semi-solid food product, to produce the desired end food product. The amount of readily-available food product is obtained by using the indicia on the then-empty container, which indicia can be variably located on the container. Once the end food product is mixed, the end food product can be placed back into the container for consumption by the user.

### PRIORITY CLAIM

This application claims the benefit of U.S. Provisional Application No. 60/585,215, filed Jul. 2, 2004.

### FIELD OF THE INVENTION

This invention relates generally to food products, containers for use with food products, and methods for making food products. More particularly, it relates to a base food preparation that is combined with a container, which container, when emptied, is used to measure a volume of a readily-available added food product to the base food preparation, which base food preparation and added food product are mixed in a food blender to form a blended end food product. In one embodiment, the blended end food product may then be dispensed from the food blender and back to the container for consumption directly from that container.

### BACKGROUND OF THE INVENTION

In the experience of this inventor, there are many food products that can be formulated using a conventional food blender. Such products include, without limitation, chip dips, fruit drinks, fortified energy drinks, and smoothies. Such food products are, quite obviously, the result of a number of base ingredients being blended together to form the desired end food product. The base ingredients may assume many forms. Such forms might include, without limitation, dry food powders, freeze-dried foods, frozen foods and fresh foods, or combinations of dry food preparations, freeze-dried food preparations, frozen preparations, and fresh preparations.

It is also well known in the art of food preparation that the final food product may be limited in its shelf life and, in fact, may have no shelf life when prepared in a desired form. A good example of such a food product would be a fruit-based smoothie. Another would be a fruit and yogurt-based smoothie. While satisfactory for consumption in final form, there really is no practical way to keep such products fresh for any extended period of time.

Accordingly, what is needed is a reconstitutible base food preparation that can be added to another readily-available food product to produce a desired, blended end food product. It is also desirable that the base food preparation be provided to the user, and be contained within, a readily-usable container. It is further desirable to provide a container that includes an indicator for the addition of a pre-measured volume of readily-available food product, such amount to be added to the container following removal of the base food preparation from the container to a food blender. It is yet another desired result to provide a container that can be used as a food serving vessel for the end food is product following blending of the base food preparation with the readily-available food product within the blender.

Accordingly, it is an object of the present invention to provide a new and useful food container that combines food-holding capabilities with food-measuring capabilities. It is another object to provide such a container with the foregoing capabilities and further combining them with food-serving capabilities. It is still another object to provide such a container that can be constructed to be disposable in use. It is yet another object to provide such a container that can be constructed to be combined with and to accommodate food preparations of virtually any type or size. It is still a further object to provide a base food preparation that is pre-packaged within the container for convenient use by consumers and that can be stored within the container until use is desired. It is yet another object to provide a base food preparation that can assume a dry state, a frozen state, or other state as such is desired or required. It is still another object to provide a base food preparation which, when blended with a readily-available food product, such as a liquid or a semi-solid food product, produces a desirable end food product. And, it is still another object to provide a container that includes indicia for measuring a volume of readily-available food product, such product being used to supplement and to reconstitute the base food preparation provided in accordance with the instant invention.

### SUMMARY OF THE INVENTION

The preparation, apparatus and method of the present invention has obtained these objects. It provides for a food container that combines food-holding capabilities with food-measuring capabilities and with food-serving capabilities. The container is is formed in a cup-like configuration having an open end. As constructed, the container can accommodate and be combined with base food preparations of essentially any type or size. The container also includes indicia for measuring a volume of readily-available food product, such product being used to supplement the base food preparation that is pre-packaged within the container. In this fashion, the container and the pre-packaged base food preparation are convenient in their use by consumers and both can be stored together without degradation of the base food preparation until use is desired. In the preferred embodiment, the base food preparation can assume a dry state, a frozen state, or any other state as such is desired or required to formulate the end food product. In the method of the present invention, the base food preparation is removed from the container to a blender and is then blended with a readily-available food product, such as a liquid or a semi-solid food product, to produce the desired end food product. The amount of readily-available food product is obtained by using the indicia on the then-empty container, which indicia can be variably located on the container and is functionally dependent upon the end food product specified by the packager. Once the end food product is prepared, the end food product can be placed back into the container for consumption by the user.

The foregoing and other features of the present invention will be apparent from the detailed description that follows.

### BRIEF DESCRIPTION OF THE DRAWINGS

FIG. 1A is a side elevation and cross-sectioned view of a preferred embodiment of the combined apparatus and base food preparation of the present invention.

FIG. 1B is a side elevation and cross-sectioned view of the apparatus and showing the base food preparation portion being placed within the reservoir of a food blender.

FIG. 2A is a side elevation and cross-sectioned view of the apparatus portion and showing a readily-available food product added to it up to the level of an indicator line.

FIG. 2B is a side elevation and cross-sectioned view of the blender illustrated in FIG. 1B and showing the readily-available food product being added to the blender reservoir.

FIG. 3A is a side elevation and cross-sectioned view of the blended food product being poured from the blender reservoir to the apparatus portion.

FIG. 3B is a side elevation and cross-sectioned view of the blended food product within the apparatus portion, the blended food product being ready for consumption.

### DETAILED DESCRIPTION

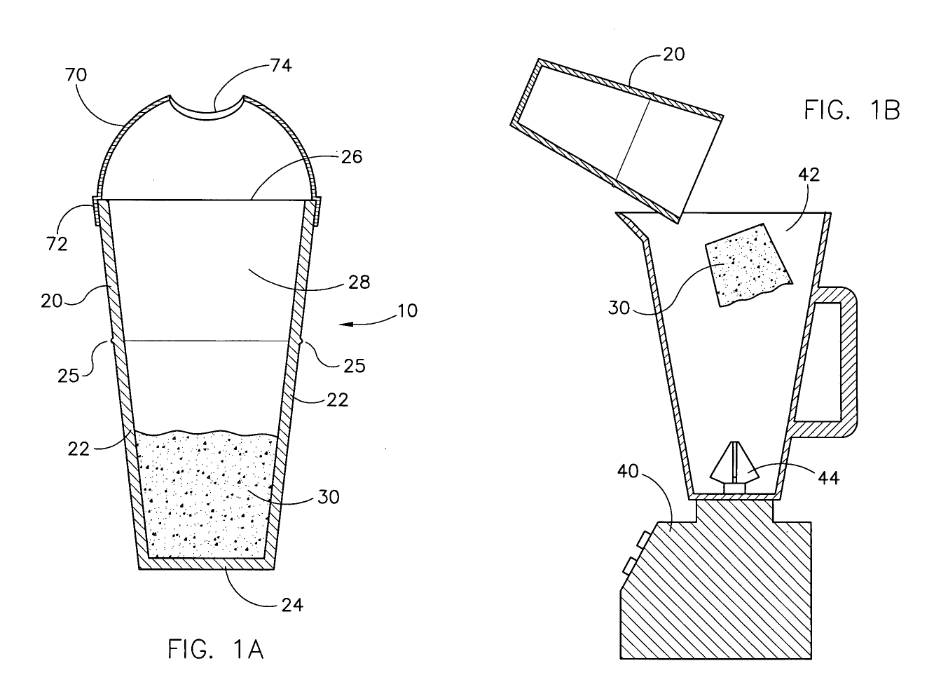

Referring now to the drawings in detail wherein like numbers represent like elements throughout, FIG. 1A illustrates a side elevational and cross-sectioned view of one embodiment of the combined apparatus and preparation, generally identified 10, constructed and pre-packaged in accordance with the present invention. As shown, the combined apparatus and preparation 10 is provided for single use purchase by a user. It is to be understood, however, that the combined apparatus and preparation 10 is not limited to a single user format and that multiple user preparations may be formulated without deviating from the present invention. The apparatus portion of the combination 10 is configured as a cup-shaped vessel 20 having a continuous sidewall 22 and a bottom floor 24. As shown, the sidewall 22 of the vessel 20 is tapered outwardly towards the open end 26 of the vessel 20. In this fashion, the contents of the vessel 20 are easily removable from the reservoir 28 of the vessel 20, regardless of the physical state of those contents. It is also to be understood that the exact shape of the vessel 20 or of the vessel sidewall 22 is not a limitation of this invention. As long as the vessel 20 includes a reservoir 28 for holding contents and an open end 26 for removing the contents therefrom, the vessel 20 will come within the scope of this invention. Furthermore, the size of the vessel 20 is not a limitation of the present invention. The vessel 20 may be configured in a small size to allow, for example, for the reconstitution of a single serving size of chip dip. So too it may be configured in a larger size to allow for the reconstitution of a quantity of smoothie product. In the preferred embodiment, the vessel 20 is constructed of a single piece of plastic material, such material being impervious to liquid penetration and being largely unaffected by substantial temperature variations. In this fashion, the vessel 20 can be frozen, kept at room temperature, or even heated. The precise material of choice is not a limitation of the present invention.

The vessel 20 also includes a distinctive mark or indicia 25 that is formed or imprinted into the sidewall 22 of the vessel 20 or printed onto a label (not shown) that encloses the sidewall 22 or a portion of the sidewall 22. The indicia or mark 25 may be incorporated into the packaging of the preparation or in the vessel sidewall 22 in many different ways, no one way being exclusively claimed by this invention. The precise function of the mark 25 will be discussed in more detail later in this detailed description.

As shown, a dome 70 is provided for attachment to the vessel 20 at the uppermost portion of the sidewall 22. For that purpose, the dome includes a dome lip 72. The dome 70 also includes a dome opening 74 through which the contents of the vessel 20 may be accessed for mixing or consumption of the contents. The presence or absence of the dome 70, or the specific form of covering for the vessel opening 26 is not a limitation of the present invention. The dome 70 could, for example, be a lid or other opening-covering structure.

The preparation portion of the combination 10 is a base food preparation 30. The base food preparation 30 can be a dried formulation, a semi-solid formulation, a frozen formulation or any other type of formulation. It is to be understood that virtually anything or any type of food product that can go into a blender can be used as the base food preparation 30 without deviating from the scope of the present invention.

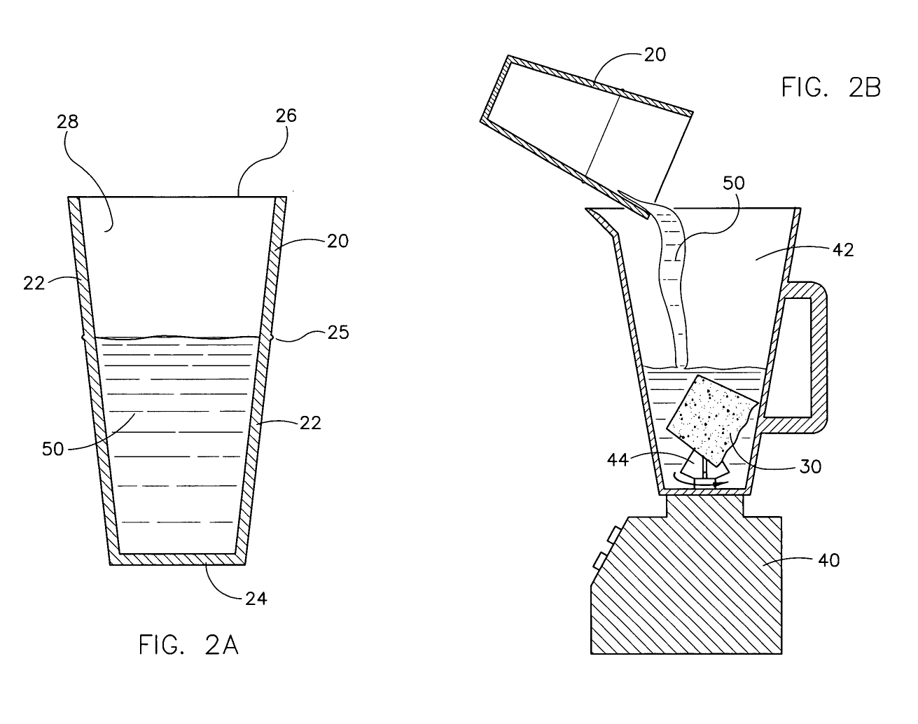

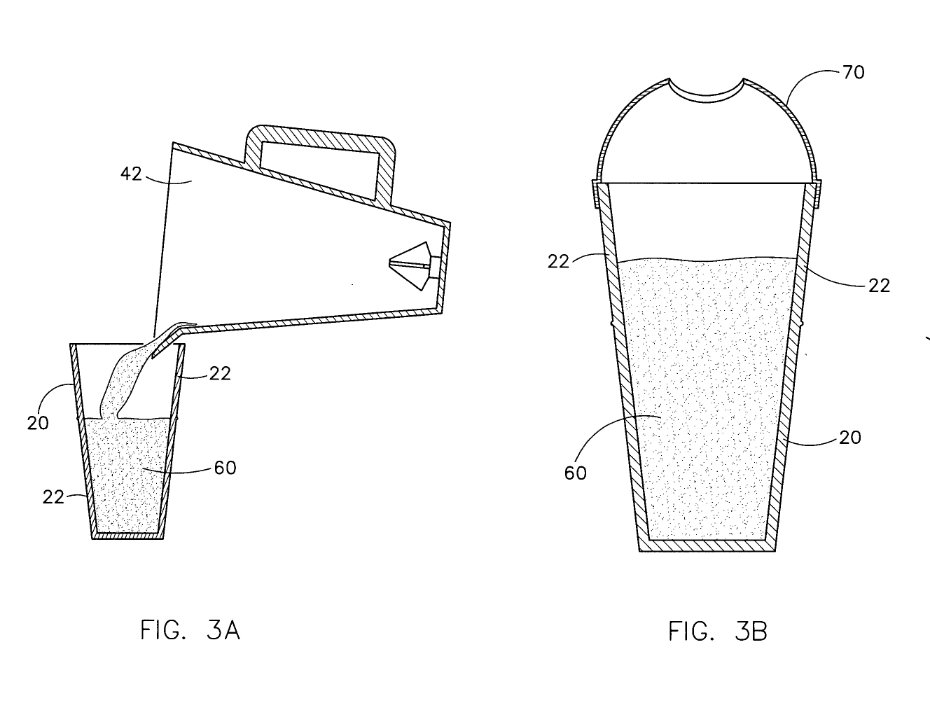

In application, the user purchases the combined apparatus and preparation 10 in a pre-packaged form as shown in FIG. 1A. Any sealing of the open end 26 of the vessel 20 is removed by the user. The base food preparation 30 is removed from the vessel 20 and placed into the mixing reservoir 42 of a blender 40. See FIG. 1B. The user, in accordance with the packager's instructions, uses the now-empty vessel 20 to measure out a given volume of a readily-available food product 50. See FIG. 2A. This is accomplished by the user filling the vessel 20 with the readily-available food product 50 to the level of the indicia 25 that is located on the vessel sidewall 22. The user then adds this volume of readily-available food product 50 to the mixing reservoir 42 of the blender 40. See FIG. 2B. The blender blades 44 are actuated to blend the base food preparation 30 and the readily-available food product 50 to produce the blended end food product 60. As shown in FIGS. 3A and 3B, this blended end food product 60 is ready for consumption and may be placed back into the vessel 22 for that purpose.

In a more specific application, where the end food product 60 is a fruit and yogurt smoothie, for example, the user follows the same steps as described above. Specifically, the user purchases the combined apparatus and preparation 10 of the smoothie preparation in a pre-packaged form. The sealing of the open end 26 of the vessel 20 is removed, as is the dome 70, and the base food preparation 30 is removed from the vessel 20 and placed into the mixing reservoir 42 of the blender 40 as shown in FIG. 1B. In this specific example, the base food preparation 30 is comprised of a mixture of slightly processed fruit parts, such as strawberry pieces and juice, and small yogurt balls. The user, in accordance with the packager's instructions, uses the now-empty vessel 20 to measure out a given volume of a readily-available food product 50, such as fresh skim milk, as shown in FIG. 2A. The user fills the vessel 20 with the readily-available food product 50 to the level of the indicia 25 that is located on the vessel sidewall 22, as shown in FIG. 2A. The user then adds this volume of readily-available food product 50 to the mixing reservoir 42 of the blender 40. See FIG. 2B. The blender blades 44 are actuated to blend the base food preparation 30 and the readily-available food product 50 to produce the blended end food product 60 which, in this example, is a strawberry-yogurt smoothie. As alluded to previously, and as is shown in FIG. 3A, this blended end food product 60 may be placed back into the vessel 20 for consumption by the user. As shown in FIG. 3B, the dome 70 may be attached to the vessel 20 and the user may use a straw or spoon to access the contents 60 for consumption.

Based upon the foregoing, it will be seen that there has been provided a new and useful food container that combines food-holding capabilities with food-measuring capabilities; that provides such a container with the foregoing capabilities and further combines them with food-serving capabilities; that provides such a container which can be disposable; that provides a container that can be constructed to be combined with and that accommodates food preparations of various types and sizes; that provides a base food preparation that is pre-packaged within the container for convenient use by consumers and that can be stored within the container until use is desired; that provides a base food preparation that can assume a dry state, a frozen state, or other state; that provides a base food preparation which, when blended with a readily-available food product, such as a liquid or a semi-solid food product, produces a desirable end food product; and that provides a container having indicia for measuring a volume of readily-available food product, such product being used to supplement and to reconstitute the base food preparation provided in accordance with the instant invention.

What is claimed is:

1. A method for preparing a food product comprising the steps of:
providing a container, the container having indicia for measuring a volume and containing a first food product;
removing the first food product;
using the measuring indicia to fill the container with a predetermined amount of a second food product, the second food product being selected from a group consisting of: water, milk, yogurt or a combination thereof;
mixing the first food product with the second food product; and
pouring the mixed food products into the container for consumption by a human being.

2. The method of claim 1 wherein the first food product removing step comprises the step of pouring the first food product into a blender.

3. The method of claim 1 wherein the container is impervious to liquid penetration.

4. The method of claim 1 further comprising the step of providing a lid to cover the opening in the container.

5. The method of claim 1 wherein the container is sealed and contains a predetermined amount of the first food product.

6. The method of claim 5 wherein the first food product is prepackaged and sealed in the container.

7. The method of claim 1 wherein the first food product comprised of processed food parts and juice and small yogurt balls.

8. The method of claim 7 wherein the first food product is a dried, dehydrated, semisolid or frozen formulation.

9. A method for preparing a food product comprising the steps of:
providing a container, the container having indicia for measuring a volume and containing a first food product;
removing the first food product;
using the measuring indicia to fill the container with a predetermined amount of a second food product, the second food product being selected from a group consisting of: water, milk, yogurt or a combination thereof;
pouring the first food product into a blender;
using the measuring indicia to fill the container with a predetermined amount of a second food product;
mixing the food product with a second food product selected from a group consisting of: water, milk, or yogurt; and
pouring the mixed food products into the container for consumption by a human being.

10. The method of claim 9 wherein the container is impervious to liquid penetration.

11. The method of claim 9 further comprising the step of providing a lid to cover the opening in the container.

12. The method of claim 9 wherein the container is sealed and contains a predetermined amount of the first food product.

13. The method of claim 12 wherein the first food product is prepackaged and sealed in the container.

14. The method of claim 9 wherein the first food product comprised of processed food parts and juice and small yogurt balls.

15. The method of claim 14 wherein the first food product is a dried, dehydrated, semisolid or frozen formulation.

16. A method for preparing a food product comprising the steps of:
providing a container having an opening and containing a first food product, the container being impervious to liquid penetration, the container having indicia for measuring a volume;
providing a lid to cover the opening in the container;
pouring the first food product from the container into a blender;
using the measuring indicia to fill the container with a predetermined amount of the second food product, the second food product selected from a group consisting of: water, milk, or yogurt;
mixing the first food product with the second food product; and
pouring the mixed food products into the container for consumption by a human being.

17. The method of claim 16 wherein the container is sealed and contains a predetermined amount of the first food product.

18. The method of claim 17 wherein the first food product is prepackaged and sealed in the container.

19. The method of claim 17 wherein the first food product comprised of processed food parts and juice and small yogurt balls.

20. The method of claim 19 wherein the first food product is a dried, dehydrated, semisolid or frozen formulation.

21. A combined food preparation and apparatus for prepackaged food preparation comprising:
a container, the container having measuring indicia;
at least one base food preparation in a self-contained package stored inside the container;
a food product; and
the base food preparation being mixed with the food product and placed back into the container.

22. The food preparation and apparatus of claim 21 wherein the container is sealed and contains a predetermined amount of the first food product.

23. The food preparation and apparatus of claim 21 wherein the first food product comprised of processed food parts and juice and small yogurt balls.

24. The food preparation and apparatus of claim 21 wherein the first food product is a dried, dehydrated, semisolid or frozen formulation.
